(19) United States
(12) Patent Application Publication
(10) Pub. No.: US 2022/0215264 A1
(43) Pub. Date: Jul. 7, 2022

(54) Heterogenous Neural Network

(71) Applicant: PassiveLogic, Inc., Salt Lake City, UT (US)

(72) Inventors: Troy Aaron Harvey, Brighton, UT (US); Jeremy David Fillingim, Salt Lake City, UT (US)

(21) Appl. No.: 17/143,796

(22) Filed: Jan. 7, 2021

(51) Int. Cl. G06N 3/08; G06N 3/04

(52) U.S. Cl. CPC G06N 3/084; G06N 3/04

(57) ABSTRACT

Heterogenous neural networks are disclosed that have neurons that represent objects in the real world or linked functions. The neurons have input and output that represent the movement of variables between the functions; their locations in the neural net represents actual object location or function location in terms of the other functions. Multiple types of inputs can be set up such that during backpropagation, only a subset of the possible inputs are backpropagated to. The activation functions of the neurons represent the physical behavior of the objects in the real world.

### FIELD OF INVENTION

The present disclosure relates to neural networks; more specifically, to heterogenous neural networks.

### SUMMARY

This summary is provided to introduce a selection of concepts in a simplified form that are further described below in the Detailed Description section. This summary does not identify required or essential features of the claimed subject matter. The innovation is defined with claims, and to the extent this summary conflicts with the claims, the claims should prevail.

Embodiments disclosed herein provide systems and methods for creation and use of a heterogenous neural network that has unrelated functions as an activation function in neurons in an artificial neural network.

In embodiments, a method is disclosed to create a neural network that solves a linked network of equations, implemented in a computing system comprising one or more processors and one or more memories coupled to the one or more processors, the one or more memories comprising computer-executable instructions for causing the computing system to perform operations comprising: creating object neurons for functions in the linked network of functions, the functions having: respective external variables that that are inputs into the respective functions, and respective internal properties of the respective functions; arranging object neurons in order of the linked functions such that a function is associated with a corresponding object neuron; and assigning the associated function to the activation function of each respective object neuron.

In some embodiments, object neurons are connected where each respective function external variable is an edge of the corresponding object neuron and wherein a value of the variable is a weight for the edge.

In some embodiments, at least two activation functions represent unrelated functions.

In some embodiments, respective functions have respective internal properties.

In some embodiments, an input associated with the corresponding object neuron, is created with the input having an edge that connects to the corresponding object neuron.

In some embodiments, a first object neuron has multiple edges connected to a second object neuron.

In some embodiments, a first object neuron has multiple edges connected to a downstream neuron, and a different number of edges connected to an upstream neuron.

In some embodiments, an activation function is comprised of multiple equations.

In some embodiments, at least two functions in the linked network of functions are unrelated.

In some embodiments, the derivative of the neural network is computed to minimize a cost function.

In some embodiments, the neural net has inputs into the neural net and computing the derivative of the neural network applies to a subset of inputs into the neural net.

In some embodiments, computing the derivative of the neural network applies to permanent neuron inputs or to temporary neuron inputs.

In some embodiments, computing the derivative of the neural network comprises using backpropagation or automatic differentiation.

In some embodiments, the cost function determines the distance between neural network output and real-word data associated with a system associated with the linked network of equations.

In some embodiments, a system is disclosed that comprises: at least one processor; a memory in operable communication with the processor, the computing code associated with the processor configured to create a neural network corresponding to a series of linked functions, the functions having input variables and output variables, at least one function having an upstream function which passes at least one variable to the function and a downstream function, to which is passed at least one variable by the function, comprising: performing a process that includes associating a neuron with each function, creating associated neurons for each function, arranging the associated neurons in order of the linked functions, creating, for each function input variable, an edge for the neuron corresponding to the function, the edge having an upstream end and a downstream end, connecting the downstream end to the neuron, connecting the upstream edge to the a neuron associated with the upstream function; creating, for each function output variable, an edge for the neuron corresponding to the function, the edge having an upstream end and a downstream end, connecting the upstream edge to the neuron, connecting the downstream edge to the neuron associated with the downstream function; and associating each function with an activation function in its associated neuron.

In some embodiments, a permanent value is associated with at least one function; and a neural net input is created for the permanent value.

In some embodiments, there are two permanent values associated with the at least one function, a neural net input is created for each of the permanent values, and a downstream edge of the neural net input for to the neuron associated with the at least one function is created.

In embodiments, input variables for a most-upstream function correspond to neural network input variables.

In embodiments, a computer-readable storage medium is disclosed which is configured with instructions which open execution by one or more processors perform a method for creating a neural network that solves a linked network of equations, the method comprising: creating object neurons for equations in the linked network of functions, the functions having: respective external variables that that are inputs into the respective functions, and respective internal properties of the respective functions; and arranging object neurons in order of the linked functions such that a function is associated with a corresponding object neuron; and assigning the associated function to the activation function of each respective object neuron.

In embodiments, at least two activation functions represent different functions.

These, and other, aspects of the invention will be better appreciated and understood when considered in conjunction with the following description and the accompanying drawings. The following description, while indicating various embodiments of the embodiments and numerous specific details thereof, is given by way of illustration and not of limitation. Many substitutions, modifications, additions or rearrangements may be made within the scope of the embodiments, and the embodiments includes all such substitutions, modifications, additions or rearrangements.

### BRIEF DESCRIPTION OF THE FIGS

Non-limiting and non-exhaustive embodiments of the present embodiments are described with reference to the following FIGURES, wherein like reference numerals refer to like parts throughout the various views unless otherwise specified.

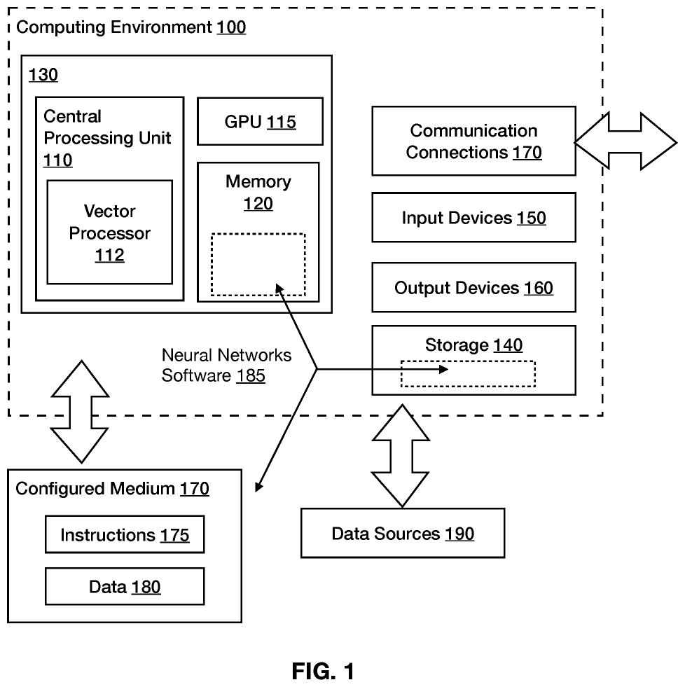

FIG. 1 is a block diagram of an exemplary computing environment in conjunction with which described embodiments can be implemented.

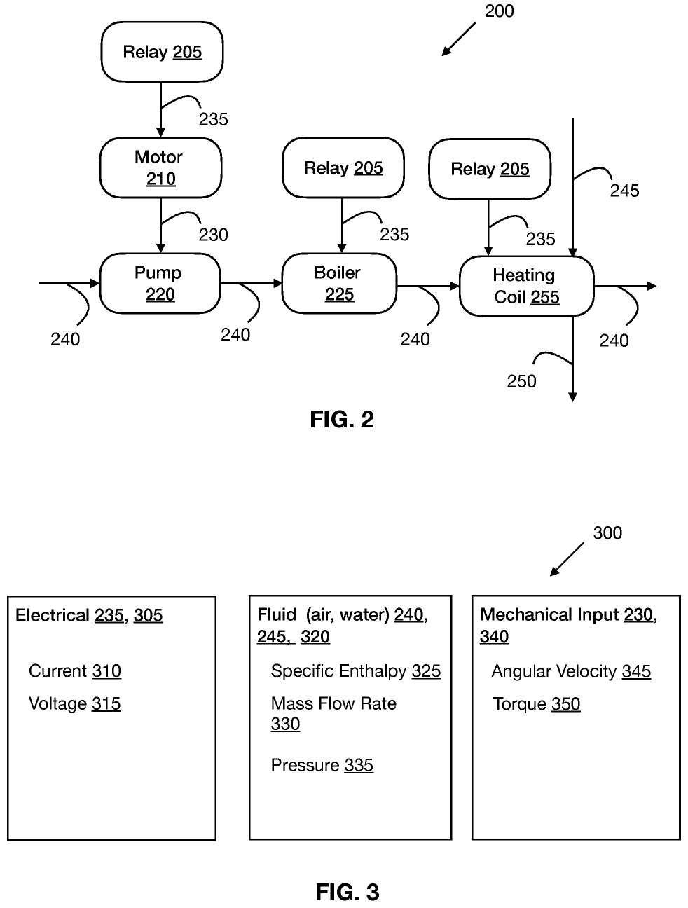

FIG. 2 depicts a physical system whose behavior can be determined by using a linked set of physics equations in accordance with one or more implementations.

FIG. 3 is a block diagram that shows variables used for certain connections in accordance with one or more implementations.

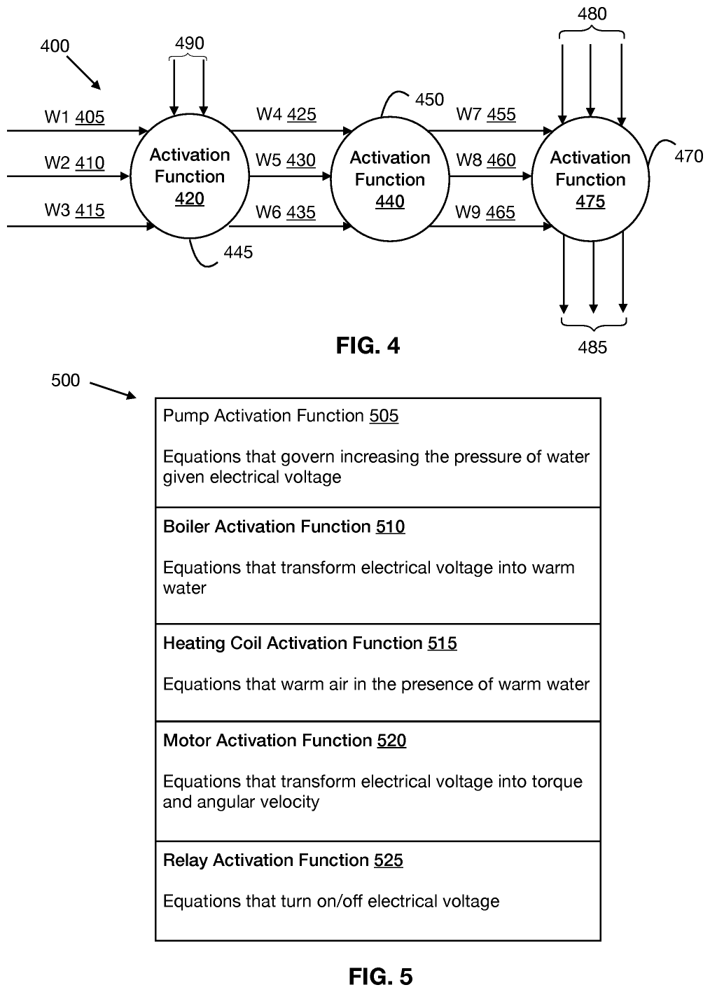

FIG. 4 depicts a portion of a neural network for a described embodiment in accordance with one or more implementations.

FIG. 5 is a block diagram that describes some general ideas about activation functions in accordance with one or more implementations.

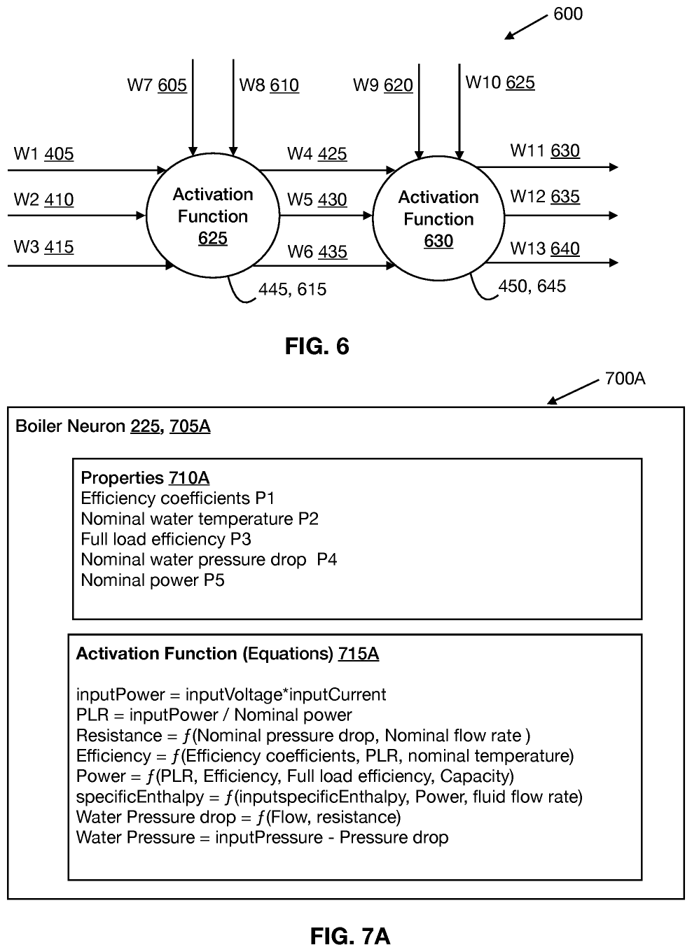

FIG. 6 is a block diagram that extends some general ideas about activation functions shown in FIGS. 4 and 5 in accordance with one or more implementations.

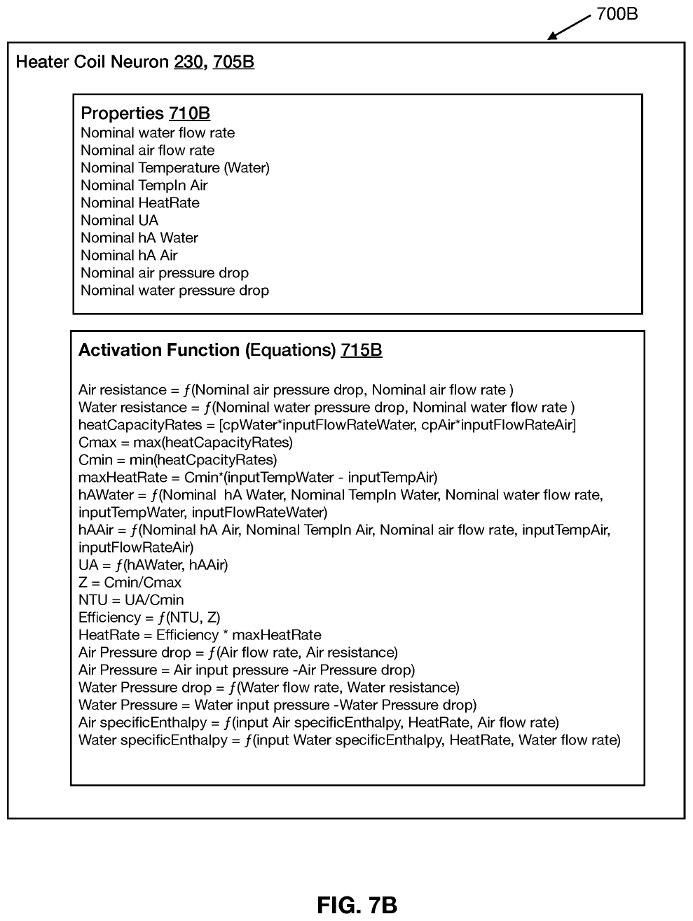

FIG. 7A depicts an exemplary boiler activation function including properties and equations in accordance with one or more implementations.

FIG. 7B depicts an exemplary heater coil activation function including properties and equations in accordance with one or more implementations.

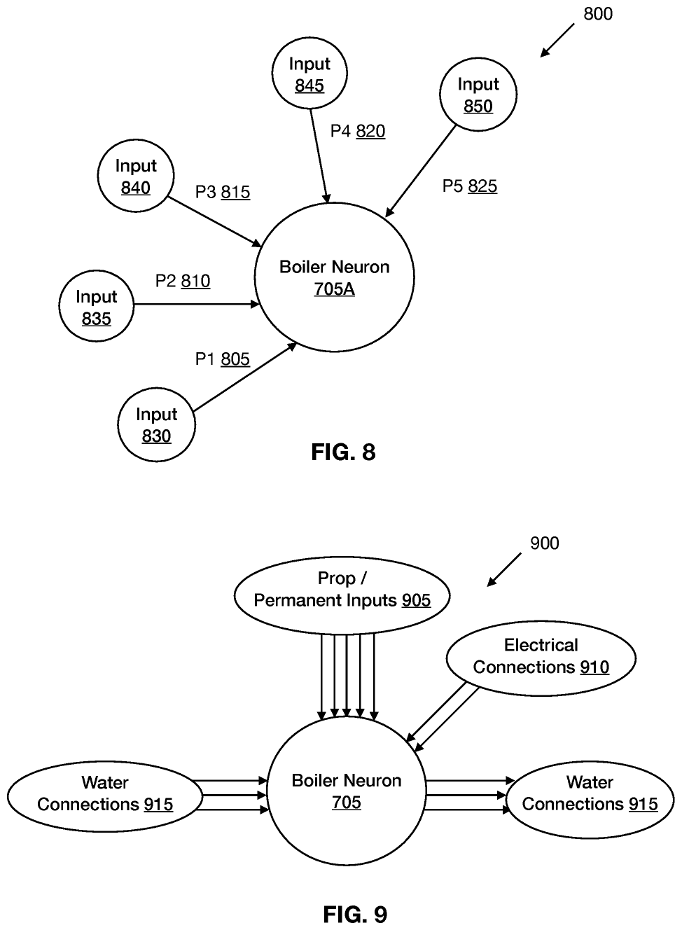

FIG. 8 is a diagram that depicts a neural net representation of properties in accordance with one or more implementations.

FIG. 9 is a diagram that depicts an exemplary neural net neuron with its associated edges in accordance with one or more implementations.

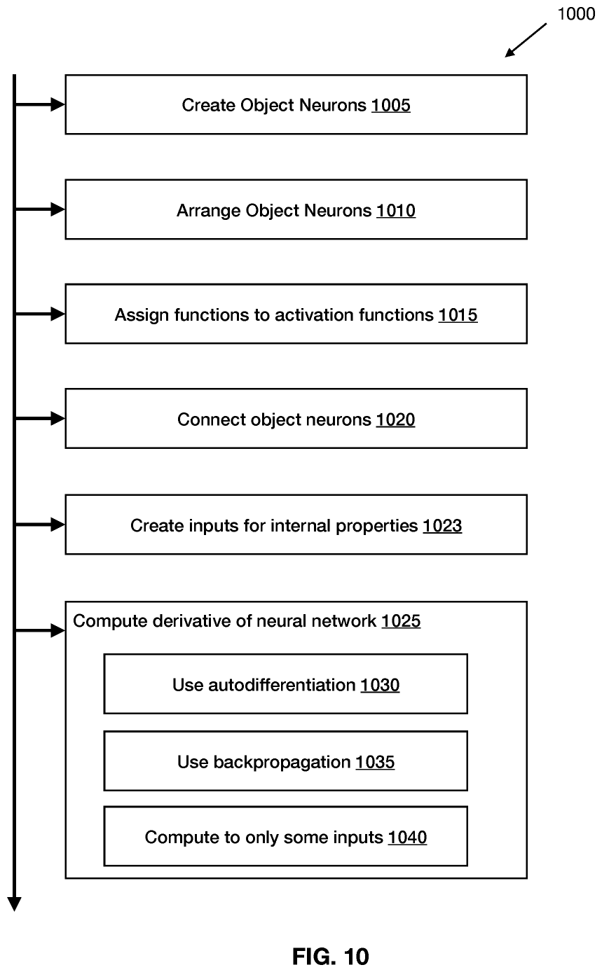

FIG. 10 is a flow diagram that describes methods to use a heterogenous neural network in accordance with one or more implementations.

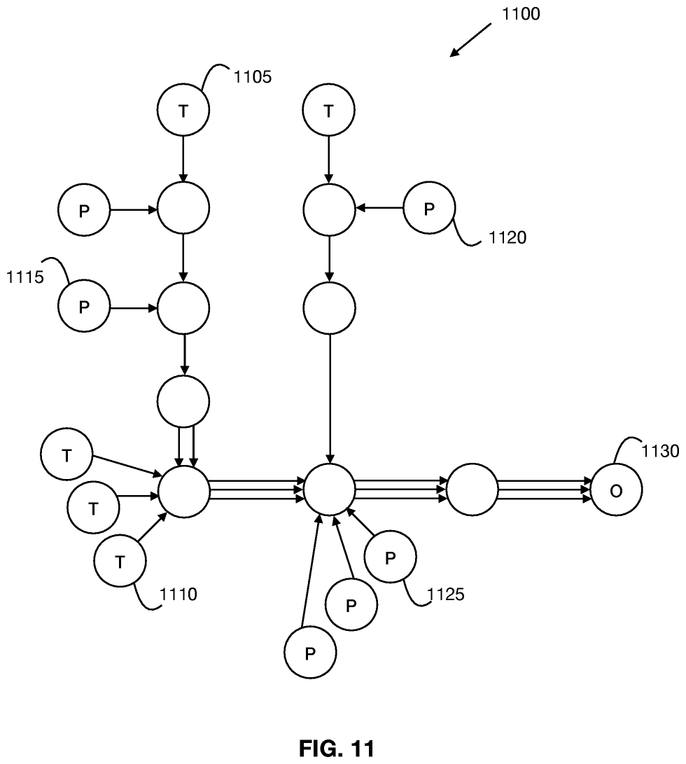

FIG. 11 depicts a topology for a heterogenous neural network in accordance with one or more implementations.

Corresponding reference characters indicate corresponding components throughout the several views of the drawings. Skilled artisans will appreciate that elements in the FIGURES are illustrated for simplicity and clarity and have not necessarily been drawn to scale. For example, the dimensions of some of the elements in the figures may be exaggerated relative to other elements to help to improve understanding of various embodiments. Also, common but well-understood elements that are useful or necessary in a commercially feasible embodiment are often not depicted in order to facilitate a less obstructed view of these various embodiments.

### DETAILED DESCRIPTION

Disclosed below are representative embodiments of methods, computer-readable media, and systems having particular applicability to heterogenous neural networks.

In the following description, numerous specific details are set forth in order to provide a thorough understanding of the present embodiments. It will be apparent, however, to one having ordinary skill in the art that the specific detail need not be employed to practice the present embodiments. In other instances, well-known materials or methods have not been described in detail in order to avoid obscuring the present embodiments.

Reference throughout this specification to “one embodiment”, “an embodiment”, “one example” or “an example” means that a particular feature, structure or characteristic described in connection with the embodiment or example is included in at least one embodiment of the present embodiments. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples.

Embodiments in accordance with the present embodiments may be implemented as an apparatus, method, or computer program product. Accordingly, the present embodiments may take the form of an entirely hardware embodiment, an entirely software embodiment (including firmware, resident software, micro-code, etc.), or an embodiment combining software and hardware aspects. Furthermore, the present embodiments may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present embodiments may be written in any combination of one or more programming languages.

Embodiments may be implemented in edge computing environments where the computing is done within a network which, in some implementations, may not be connected to an outside internet, although the edge computing environment may be connected with an internal internet. This internet may be wired, wireless, or a combination of both. Embodiments may also be implemented in cloud computing environments. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The flowchart and block diagrams in the flow diagrams illustrate the architecture, functionality, and operation of possible implementations of systems, methods, and computer program products according to various embodiments of the present embodiments. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by general or special purpose hardware-based systems that perform the specified functions or acts, or combinations of general and special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

As used herein, the terms “comprises,” “comprising,” “includes,” “including,” “has,” “having,” or any other variation thereof, are intended to cover a non-exclusive inclusion. For example, a process, article, or apparatus that comprises a list of elements is not necessarily limited to only those elements but may include other elements not expressly listed or inherent to such process, article, or apparatus.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Additionally, any examples or illustrations given herein are not to be regarded in any way as restrictions on, limits to, or express definitions of any term or terms with which they are utilized. Instead, these examples or illustrations are to be regarded as being described with respect to one particular embodiment and as being illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such non-limiting examples and illustrations includes, but is not limited to: “for example,” “for instance,” “e.g.,” and “in one embodiment.”

“Program” is used broadly herein, to include applications, kernels, drivers, interrupt handlers, firmware, state machines, libraries, and other code written by programmers (who are also referred to as developers) and/or automatically generated. “Optimize” means to improve, not necessarily to perfect. For example, it may be possible to make further improvements in a program or an algorithm which has been optimized.

Additionally, any examples or illustrations given herein are not to be regarded in any way as restrictions on, limits to, or express definitions of any term or terms with which they are utilized. Instead, these examples or illustrations are to be regarded as being described with respect to one particular embodiment and as being illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms.

### I. Overview

Artificial neural networks are powerful tools that have changed the nature of the world around us, leading to breakthroughs in classification problems, such as image and object recognition, voice generation and recognition, autonomous vehicle creation and new medical technologies, to name just a few. However, neural networks start from ground zero with no training. Training itself can be very onerous, both in that an appropriate training set must be assembled, and that the training often takes a very long time. For example, a neural net can be trained for human faces, but if the training set is not perfectly balanced between the many types of faces that exist, even after extensive training, it may still fail for a specific subset; at the best, the answer is probabilistic; with the highest probability being considered the answer.

Existing approaches offer three steps to develop a deep learning AI model. The first step builds the structure of a neural network through defining the number of layers, number of neurons in each layer, and determines the activation function that will be used for the neural network. The second step determines what training data will work for the given problem, and locates such training data. The third step attempts to optimize the structure of the model, using the training data, through checking the difference between the output of the neural network and the desired output. The network then uses an iterative procedure to determine how to adjust the weights to more closely approach the desired output. Exploiting this methodology is cumbersome, at least because training the model is laborious.

One the neural net is trained, it is basically a black box, composed of input, output, and hidden layers. The hidden layers are well and truly hidden, with no information that can be gleaned from them outside of the neural net itself. Thus, to answer a slightly different question, a new neural net, with a new training set must be developed, and all the computing power and time that is required to train a neural net must be employed.

We describe herein a heterogeneous neural net. A typical neural net comprises inputs, outputs, and hidden layers connected by edges which have weights associated with them. The neural net sums the weights of all the incoming edges, applies a bias, and then uses an activation function to introduce non-linear effects, which basically squashes or expands the weigh/bias value into a useful range; often deciding whether the neuron will, in essence, fire, or not. This new value then becomes a weight used for connections to the next hidden layer of the network. The activation function does not do separate calculations.

In embodiments described herein, the fundamentals of physics are utilized to model single components or pieces of equipment on a one-to-one basis with neural net neurons. When multiple components are linked to each other in a schematic diagram, a neural net is created that models the components as a neurons. The values between the objects flow between the neurons as weights of connected edges. These digital analog neural nets model not only the real complexities of systems but also their emergent behavior and the system semantics. Therefore, it bypasses two major steps of the conventional AI modeling approaches: determining the shape of the neural net, and training the neural net from scratch. As the neurons are arranged in order of an actual system (or set of equations) and because the neurons themselves comprise an equation or a series of equations that describe the function of their associated object, and certain relationships between them are determined by their location in the neural net. Therefore, a huge portion of training is no longer necessary, as the neural net itself comprises location information behavior information, and interaction information between the different objects represented by the neurons. Further, the values held by neurons in the neural net at given times represent real-world behavior of the objects so represented. The neural net is no longer a black box but itself contains important information. This neural net structure also provides much deeper information about the systems and objects being described. Since the neural network is physics- and location-based, unlike the conventional AI structures, it is not limited to a specific model, but can run multiple models for the system that the neural network represents without requiring separate creation or training.

In one embodiment, the neural network that is described herein shapes the location of the neurons to tell you something about the physical nature of the system and places actual equations into the activation function. The weights that move between neurons are equation variables. Different neurons may have unrelated activation functions, depending on the nature of the model being represented. In an exemplary embodiment, each activation function in a neural network may be different.

As an exemplary embodiment, a pump could be represented in a neural network as a series of network neurons, some that represent efficiency, energy consumption, pressure, etc. The neurons will be placed such that one set of weights (variables) feeds into the next neuron (e.g., with an equation as its activation function) that uses those weights (variables). Now, two previous required steps, shaping the neural net and training the model may already be performed, at least to a large part. Using embodiments discussed here the neural net model need not be trained on information that is already known.

In some embodiments, the individual neurons represent physical representations. These individual neurons may hold parameter values that help define the physical representation. As such, when the neural net is run, the parameters helping define the physical representation can be tweaked to more accurately represent the given physical representation.

This has the effect of pre-training the model with a qualitative set of guarantees, as the physics equations that describe objects being modeled are true, which saves having to find training sets and using huge amounts of computational time to run the training sets through the models to train them. A model does not need to be trained with information about the world that is already known. With objects connected in the neural net like they are connected in the real world, emergent behavior arises in the model that maps to the real world. This model behavior that is uncovered is otherwise too computationally complex to determine. Further, the neurons represent actual objects, not just black boxes. The behavior of the neurons themselves can be examined to determine behavior of the object, and can also be used to refine the understanding of the object behavior.

### II. Computing Environment

FIG. 1 illustrates a generalized example of a suitable computing environment 100 in which described embodiments may be implemented. The computing environment 100 is not intended to suggest any limitation as to scope of use or functionality of the disclosure, as the present disclosure may be implemented in diverse general-purpose or special-purpose computing environments.

With reference to FIG. 1, the computing environment 100 includes at least one central processing unit 110 and memory 120. In FIG. 1, this most basic configuration 130 is included within a dashed line. The central processing unit 110 executes computer-executable instructions and may be a real or a virtual processor. It may also comprise a vector processor, which allows same-length neuron strings to be processed rapidly. The environment 100 further includes the graphics processing unit GPU at 115 for executing such computer graphics operations as vertex mapping, pixel processing, rendering, and texture mapping. In a multi-processing system, multiple processing units execute computer-executable instructions to increase processing power and as such the vector processor 112, GPU 115, and CPU can be running simultaneously. The memory 120 may be volatile memory (e.g., registers, cache, RAM), non-volatile memory (e.g., ROM, EEPROM, flash memory, etc.), or some combination of the two. The memory 120 stores software 185 implementing the described methods of heterogenous neural net creation and implementation.

A computing environment may have additional features. For example, the computing environment 100 includes storage 140, one or more input devices 150, one or more output devices 160, and one or more communication connections 170. An interconnection mechanism (not shown) such as a bus, controller, or network interconnects the components of the computing environment 100. Typically, operating system software (not shown) provides an operating environment for other software executing in the computing environment 100, and coordinates activities of the components of the computing environment 100. The computing system may also be distributed; running portions of the software 185 on different CPUs.

The storage 140 may be removable or non-removable, and includes magnetic disks, magnetic tapes or cassettes, CD-ROMs, CD-RWs, DVDs, flash drives, or any other medium which can be used to store information and which can be accessed within the computing environment 100. The storage 140 stores instructions for the software 185 to implement methods of neuron discretization and creation.

The input device(s) 150 may be a device that allows a user or another device to communicate with the computing environment 100, such as a touch input device such as a keyboard, video camera, a microphone, mouse, pen, or trackball, a scanning device, touchscreen, or another device that provides input to the computing environment 100. For audio, the input device(s) 150 may be a sound card or similar device that accepts audio input in analog or digital form, or a CD-ROM reader that provides audio samples to the computing environment. The output device(s) 160 may be a display, printer, speaker, CD-writer, or another device that provides output from the computing environment 100.

The communication connection(s) 170 enable communication over a communication medium to another computing entity. The communication medium conveys information such as computer-executable instructions, compressed graphics information, or other data in a modulated data signal. Communication connections 170 may comprise a device 144 that allows a client device to communicate with another device over network 170. A communication device may include one or more wireless transceivers for performing wireless communication and/or one or more communication ports for performing wired communication. In embodiments, communication device 144 may be configured to transmit data associated [[describe data transferred]] to information server These connections may include network connections, which may be a wired or wireless network such as the Internet, an intranet, a LAN, a WAN, a cellular network or another type of network. It will be understood that network 170 may be a combination of multiple different kinds of wired or wireless networks. The network 170 may be a distributed network, with multiple computers acting in tandem.

A computing connection 170 may be a portable communications device such as a wireless handheld device, a cell phone device, and so on.

Computer-readable media are any available non-transient tangible media that can be accessed within a computing environment. By way of example, and not limitation, with the computing environment 100, computer-readable media include memory 120, storage 140, communication media, and combinations of any of the above. Configurable media 170 which may be used to store computer readable media comprises instructions 175 and data 180. Data Sources 190 may be computing devices, such as a general hardware platform servers configured to receive and transmit information over the communications connections 170. Data sources 190 may be configured to communicate through a direct connection to an electrical controller. The competing environment 100 may be an electrical controller that is directly connected to various resources, such as HVAC resources, and which has CPU 110, a GPU 115, Memory, 120, input devices 150, communication connections 170, and/or other features shown in the computing environment 100. The computing environment 100 may be a series of distributed computers. These distributed computers may comprise a series of connected electrical controllers.

Moreover, any of the methods, apparatus, and systems described herein can be used in conjunction with combining abstract interpreters in a wide variety of contexts.

Although the operations of some of the disclosed methods are described in a particular, sequential order for convenient presentation, it should be understood that this manner of description encompasses rearrangement, unless a particular ordering is required by specific language set forth below. For example, operations described sequentially can be rearranged or performed concurrently. Moreover, for the sake of simplicity, the attached figures may not show the various ways in which the disclosed methods, apparatus, and systems can be used in conjunction with other methods, apparatus, and systems. Additionally, the description sometimes uses terms like “determine,” “build,” and “identify” to describe the disclosed technology. These terms are high-level abstractions of the actual operations that are performed. The actual operations that correspond to these terms will vary depending on the particular implementation and are readily discernible by one of ordinary skill in the art.

Further, data produced from any of the disclosed methods can be created, updated, or stored on tangible computer-readable media (e.g., tangible computer-readable media, such as one or more CDs, volatile memory components (such as DRAM or SRAM), or nonvolatile memory components (such as hard drives) using a variety of different data structures or formats. Such data can be created or updated at a local computer or over a network (e.g., by a server computer), or stored and accessed in a cloud computing environment.

### III. Exemplary Neural Network Depictions

FIG. 2 depicts a physical system whose behavior can be determined by using a linked set of physics equations. A relay 205 sends power 235 to a motor 210; e.g., the motor is turned on. The motor 210 sends mechanical input 230 to a pump 220. This activates the pump 220 which then pumps water 240 to a boiler 225 which heats the water up, and then sends the heated water 240 to a heating coil 255 which transfers the heat from the water to air 245. The boiler 225 and heating coil 255 are activated by relays 205 sending power 235 to them. The heating coil 255 accepts air 245, which is heated by the heated water 240 coming out of the boiler, creating heated air 250.

FIG. 3 depicts a block diagram 300 that shows variables used for certain inputs that can be thought of as weights associated with edges with reference to standard neural networks) in some embodiments, such as the embodiment shown in FIG. 2. Electrical power 235 has two variables associated with it, current 310 and voltage 315. Fluid, when used as an input in this system, has, associated with it three variables: specific enthalpy 325, mass flow rate 330, and pressure 335. Both water 240 and air 245 are considered fluids. Mechanical input, when used as an input in this system, has associated with it angular velocity 345, and torque 350. These are just a small subset of the possible inputs and the possible variables for any given input.

FIG. 4 depicts a portion of a neural network 400 for a described embodiment. This embodiment is a partial representation of the pump 220, the boiler 225, and the heating coil 255. Neuron 445, the pump, has a water connection 240, 320. An upstream connection refers to inputs and/or values needed for the neuron, while downstream is the other end, after values have been transformed (or passed through) and sent to other neurons and/or outputs. The water connection in the diagram is three variables that are represented as weights connected along edges to downstream to neuron 445. The neuron is connected to three edges 405, 410, 415 with weights that represent the fluid (water) variables with weights W1 (specific enthalpy 325), W2 (Mass Flow Rate 330), and W3 (pressure 335). Neuron 445 also has three downstream connection edges 425, 430, 435 that represent the same fluid (water) variables with weights W4 (specific enthalpy 325), W5 (Mass Flow Rate 330), and W6 (pressure 335), that been transformed by the activation function 420. Neuron 450 representing the boiler, has three upstream connection edges 425, 430, 435 and weights W4, W5, W6 that are the downstream edges and weights from Neuron 445. This neuron 450 sends three downstream connection edges 455, 460, 465 and transformed weights W7, W8, W9 (specific enthalpy, mass flow rate, and pressure) to neuron 470. Similarly, neuron 470, which represents the heating coil, has three upstream connection edges 455, 460, 465 that it receives from the same neuron 450. Neuron 470 also has fluid (air) upstream connections (specific enthalpy, mass flow rate, and pressure), and corresponding downstream connections 485. The activation function 475 transforms the upstream weights 480 into the downstream weights 485.

Notice that a neuron may have multiple edges connected to, and inputting to the same downstream neuron. Similarly, a neuron may have multiple output edges connected to the same neuron upstream.

Activation functions in a neuron transform the weights on the upstream edges, and then send none, some, or all of the transformed weights to the next neuron(s). Not every activation function 420, 440, 475 transforms every weight. Some activation functions may not transform any weights.

FIG. 5 is a block diagram 500 that describes some general ideas about activation functions. Activation functions 505 for our example pump, e.g., 220, comprise equations that govern increasing the pressure of water given electrical voltage. In some instances, the activations for the pump comprise equations that govern increasing the pressure of water when given specific mechanical input, such as angular velocity 345 and torque 350. Boiler activation functions 510 may be equations that use electrical voltage to warm water. Heating coil activation functions 515 may be equations that warm air by a certain amount in the presence of warm water, cooling the water in the process. Motor activation functions 520 may be equations that transform electrical voltage into torque and/or angular velocity. Relay activation functions 525 may be equations that turn electrical voltage on and off, and/or set electrical voltage to a certain value. These are functions that use variables of various types to transform input, to solve physics equations, etc.

FIG. 6 is a block diagram of a partial neural net 600 that extends some general ideas about activation functions shown in FIGS. 4 and 5. With reference to FIG. 2, the pump 220, the boiler 225, and the heating coil have water inputs 320. The pump 220 also has mechanical input 340, and the boiler 225 heating coil also has electrical input. The neuron 615 representing the pump 220 therefore has, besides the three upstream connections with weights from water (405, 410, 415), another two connections 605, 610 from the mechanical input 230. These are 605 (with weight W7 representing angular velocity 345) and 610 (weight W8 representing torque 350). The boiler 225 has electrical input 235, which are represented in the boiler neuron 645 as the edge 620 and weight W9 (current 310) and edge 625 and weight W10 (voltage 315). Overall, we see that the neuron 615 has five edges with weights as upstream connections, and three edges with weights as downstream connections. The mechanical input does not have downstream connections, but is used in the activation function. There is no requirement that the upstream edges are represented in the downstream edges. Neuron 645 also has five upstream edges, two representing electrical variables, edge 620 with weight W7 representing current 310 and edge 625 with weight W9 representing voltage; and three edges with weights (W4 425, W5 430, W6 435) representing fluid 320, and three associated downstream edges with weights also representing fluid, W11 630, W12 635, and W13 640. The activation function 625 transforms the upstream weights and passes them to the next activation function(s) 630 down the line using the weights on its downstream edges. This can be thought of as variables entering and leaving function, with the weights being the variable values.

FIG. 7 depicts an exemplary neuron 700A (e.g. 225, 645, a neuron representing an exemplary boiler) including properties 710A and equations 715A. Properties 710A are properties of the object being represented by the neuron, in this case a boiler. The object, in some cases will have default values of these properties. However, any given object (e.g., the boiler) may deviate from these default values when functioning in the real world. Running the simulation may be able to determine better values of these properties. For this specific boiler, the properties are efficiency coefficients P1, Nominal water temperature P2, Full load efficiency P3, Nominal pressure drop P4 and Nominal power P5. Running the simulation and comparing output of the simulation with actual machine output may be able to determine better values of these properties.

Neurons have activation functions. Rather than being a simple equation used over most or all of a neural net to introduce non-linearality into the system with the effect of moving any given neuron's output into a desired range, activation functions in some embodiments disclosed here are one or more equations that determine actual physical behavior of the object that the neuron represents. In some embodiments, the activation functions represent functions in a system to be solved. These equation(s) have both input variables that are represented in the neural net as edges with weights, and variables that are properties 710A of the object itself. A representative set of equations to model boiler behavior is shown at 715A. The properties may be represented as input neurons into the neural network with edges connected to the boiler neuron.

FIG. 7B depicts an exemplary neuron 700B (e.g. 255; a neuron representing an exemplary heater coil) including properties 710B and equations 715B. The definition of the properties of two neurons may be completely different, may share property types, or may be similar. However, each neuron has its own properties that have their own values as will be explained with reference to FIG. 11. For example property 710A of Neuron 705A and 710B share one property, nominal temperature (water). Otherwise, their properties are different. The boiler activation functions 715A share a couple of similar equations with the heating coil activation functions 715B (e.g., water pressure drop, water pressure) but the bulk of the equations are different. For some neurons, all the equations in the activation functions will be different. In some embodiments, for some neurons, the activation functions may be the same, such as for the relays 205 shown in FIG. 2.

FIG. 8 is a diagram 800 that depicts a partial neural net representation of properties 710A. For simplicity and readability, not all inputs and outputs of this boiler neuron 705A is shown. In some implementations, properties are represented as inputs with weights into a neuron with the properties having no corresponding outputs. The boiler neuron 705A represented herein has five properties 710A that are represented as neural net inputs (that at the beginning of a run are given starting values) 830, 835, 840, 845, and 850; edges 805, 810, 815, 820, 825; with weights P1-P5. These correspond to efficiency coefficients P1, Nominal water temperature P2, Full load efficiency P3, Nominal pressure drop P4 and Nominal power P5. For a single example, efficiency coefficient P1 has an input 830 that is given a value at the start of a neural net feedforward run, Its value is used as the weight P1 along edge 805 that passes to the boiler neuron 705A, where it is most likely used in calculations. The activation function equations 715A may require both the incoming connections with their weights, which can be though of as temporary variables) and the properties, which can be thought of as permanent variables. Permanent variables, in some embodiments, describe properties of the objects being modeled, such as the boiler. Modifying the properties will modify how the objects, such as boiler, etc behave.

As the properties are inputs, backpropagation to the properties will allow the neural network system to be tested at the output(s) against real system data. The cost function can measure the difference between the output of the neural network and the output of the actual system under similar starting conditions. The starting conditions can be provided by inputs which may be temporary inputs or a different sort of input. The backpropagation minimizes the cost function. This process can be used to fine-tune the neural network to more closely match the real-world system. Temporary variables, in some embodiments, describe properties of the state of the system. Modifying the inputs of the temporary variables will modify the state of the system being modeled by the neural network, such that inputting a state will change the state of the system throughout as the new state works its way through the system. Inputs into the variables, such as the temporary variables may be time curves. Inputs into the permanent variables may also be time curves whose value does not change over time. Unlike traditional neural nets, whose hidden variables are well and truly hidden such that their intermediate values are indecipherable to users, values of the neurons during running a neural net (e.g., midway through a time curve, at the end of a run, etc.) can produce valuable information about the state of the objects represented by the neurons. For example, the boiler at a given moment has values in all its activation function equations that describe the nature of the boiler at that given time.

FIG. 9 is a diagram 900 that depicts a portion of an exemplary neural net neuron with its associated edges. This boiler neuron 705 has three water variable weight edges 915 from pump 220, two electrical edges 910 from relay 205, and five property edges 905 that are associated with the neuron itself. The weights of the edges are used in the equations 715 to produce three downstream edges 915 with weights that represent water variables 320.

When a fully constituted neural network runs forward it changes weights as per the calculations at the individual neurons. Input, e.g., into the relay over time (e.g., in the form of a time curve) can modify the workings of the neural network by switching objects on and off, or by modifying the amount a given object is on. Other modifications that change what parts of a neural network are running at a particular time are also included within the purview of this specification. Unlike standard neural nets, at a given time, neurons that represent physical objects can switch on an off, such as a relay 205 turning on at a certain time, sending electricity 235 to a boiler, to give a single example, changing the flow of the neural net. Similarly, a portion of the neural net can turn off at a given time, stopping the flow of a portion of the neural net. If the relay 205 were to turn off, then the boiler 225 will cease to run.

FIG. 10 is a flow diagram that describes methods to use a heterogenous neural network. The operations of method 1000 presented below are intended to be illustrative. In some embodiments, method 1000 may be accomplished with one or more additional operations not described, and/or without one or more of the operations discussed. Additionally, the order in which the operations of method 1000 are illustrated in FIG. 10 and described below is not intended to be limiting.

In some embodiments, method 1000 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 1000 in response to instructions stored electronically on an electronic storage medium. The one or more processing devices may include one or more devices configured through hardware, firmware, and/or software to be specifically designed for execution of one or more of the operations of method 1000.

In some embodiments, a neural network method solves a linked network of equations. This linked network of equations may be equations representing a physical system, such as the one described in FIG. 2 at 200, though any linked set of equations may be used. In some implementations, these equations or groups of equations may be represented by functions. At operation 1005, object neurons are created for the functions in the linked network of functions. With reference to FIGS. 2 and 3, each of the physical objects whose physical characteristics may be represented by equations. i.e., each of the three relays 205, the motor 210, the pump 220, the boiler 225, and the heating coil 255 have object neurons created for them. The functions (which represent an equation or groups of equations) have respective external variables that that are inputs into the respective functions. The external variables in this exemplary embodiment represent three types of variables, electrical 235, 305, fluid 240, 245, 320, and mechanical input 230, 340. The fluid input represents air 245 and water 240. With reference to FIG. 4, each of these fluid inputs has three external variables—for an example, W1 405, W2 410, W3 415, corresponds to the water fluid input 240, 320; while the fluid input 480 with its three input edges corresponds to the air fluid input 245, 320. The electrical and mechanical inputs represent two external variables. The mechanical input 230, 340 has two inputs 490 into the neuron 445 representing the pump 220. In some embodiments, the respective neurons also have inputs that represent internal properties of the respective functions. With reference to FIGS. 2, 7A, and 8, the function that represents the boiler 225 comprises a series of equations 715A that have a number of internal properties 710A. These properties are represented as inputs 805-825 with edges that connect to the boiler 705.

At operation 1010, object neurons are arranged in order of the linked functions such that a function is associated with a corresponding object neuron. With reference to FIGS. 2 and 4, to model the system shown, object neurons will be arranged in order of each of the objects that are to be modeled, such that the neuron 445, which represents the pump, is attached to neuron 450, the boiler, which is attached to neuron 470, the heating coil. A neuron representing the motor 210 (not shown) is attached to the neuron 445 though the edges 490; a neuron (not shown) representing the relay 205 is attached to the neuron representing the motor (not shown), etc.

At operation 1015, the associated function is assigned to the activation function of each respective object neuron. Each object has a function that represents an equation or a series of equations. Examples of this can be seen with reference to FIG. 7A, showing a possible function comprising multiple equations 715A for the boiler object 225. FIG. 7B shows a possible function comprising multiple equations 715B for the heater coil object 255. With reference to FIG. 4, The equations 715A that represent the boiler neuron 450 are assigned to the activation function 440 for the boiler neuron 450. Similarly, the equations 715B that represent the heater coil neuron 470 are assigned to the activation function 475 for the heater coil neuron 470. In some instances, the activation functions of the neurons in the neural are different. In some instances, some of the neurons in the neural net have the same functions, but others have different activation functions. For example, in the example shown in FIG. 2, the relay objects 205 may give rise to neurons that have similar activation functions, while the motor 210, pump 220, boiler 225, and heating coil 255 all are represented by neurons with different activation functions representing the physical qualities of the respective objects.

At operation 1020, object neurons are connected such that each respective function external variable is an edge of the corresponding object neuron and a value of the variable is a weight of the edge. With reference to FIGS. 2, 3, and 4, the pump has a fluid input 240 and a fluid output 240. A fluid 320 is represented by three variables, such that a neuron 445 representing the pump object 220 has three edges with weights: Specific Enthapy 325, Mass Flow Rate 330, and Pressure 335. These are all represented as upstream input variables 405, 410, 415 for the neuron 445 representing the pump 220. The motor 210 also has two 345, 350 mechanical input variables 230 used within the pump 220. These are also represented as edges 490 entering the pump neuron 445. Also these five weights/values from the five edges can then be used in the activation function 420. The pump 220 also has fluid output 240. This fluid output is the three variables shown with reference to 320, and already discussed above. These become output downstream edges to neuron 445 and input upstream edges to neuron 450. The weight values comprise variables of immediately downstream neurons. For an example, a Specific enthalpy 325 value represented as weight W1 enters neuron 445, is transformed by the activation function 420 to weight W4, exits along edge 425 which connects to neuron 450, which represents the boiler 225. The two mechanical value weights W7 605 and W8 610 (e.g., 490 in FIG. 4) enter the neuron 445 from a neuron that represents the motor 210 (not shown), and are used in the neuron 420 activation function, but do not exit. It can thus be seen that the neurons that have edges with weights entering them are connected as seen in FIG. 2. With reference to FIGS. 3, 4 and 7A, the activation function 715A of an exemplary boiler neuron 705 uses the weight values 425, (Specific Enthalpy 325), 430 (Mass Flow Rate 330), and 435 (Pressure 335). These variables have “input” prepended to the specific variable name within the activation function equations 715A listed in FIG. 7A.

At operation 1023, inputs are created for internal properties. Respective functions have respective internal properties, as seen with reference to properties 710A and 710B in FIGS. 7A and 7B. The boiler neuron 705A has five internal properties 710A—P1 through P5. The heater coil neuron 705B has ten internal properties. These internal properties have an input created that is associated with the corresponding object neuron, the input having an edge that connects to the corresponding object neuron. For example, with reference to FIG. 8, the five internal properties of the boiler each have a neural net input 830-850 with an edge 805-825 with an associated weight P1-P5 entering the boiler neuron 705A. These properties may then be used to calculate the activation function of this neuron.

FIG. 11 depicts one topology 1100 for a heterogenous neural network. For simplicity and readability, only a portion of the neurons are labeled. This neural network roughly describes the physical system shown in FIG. 2 with an emphasis on types of input into the neural network. The neurons labeled with “T,” e.g., 1105, 1110, etc., represent one type of input, called here temporary inputs, while the neuron labeled “P,” e.g., 1115, 1120, 1125, etc. represent another type of input, called here permanent inputs, which may also be known as properties. The neuron labels “O,” 1130, represents the output(s). The neural network runs forward from the inputs (T and P) to the output(s) 1130. Then, a cost function is calculated. In some embodiments, the neural network represents a physical system (such as the HVAC system shown in FIG. 2). In such cases, the cost function may measure the difference between the output of the neural network and the measured behavior of the physical system the neural network is modeling.

The neural net runs forward first, from the inputs to the outputs. With the results, a cost function is calculated. At operation 1025, the derivative of the neural network is calculated. In prior neural networks, each activation function in the neural network is the same. This has the result that the same gradient calculation can be used for each neuron. In embodiments disclosed here, each neuron has the potential of having different equations, and therefore different gradient calculations are required to calculate the derivative of each neuron. This makes using standard backpropagation techniques slower, though certainly still possible. However, when the equations are differentiable then autodifferentiation may be used to compute the derivative of the neural network. Autodifferentiation allows the gradient of a function to be calculated as fast as calculating the original function times a constant, at worse. This allows the complex functions involved in the heterogenous neural networks to be calculated within a reasonable time.

At operation 1030, automatic differentiation is used to compute the derivative of the neural network. Other methods of gradient computation are envisioned as well. For example, as shown at operation 1035, in some embodiments, backpropagation is used to compute the derivative of the neural network. This may be used, for example, when the equations are not all differentiable. When the neural network is modeling the real world, such as shown in FIG. 2, data from the system running can be used as the measure for the cost function. The cost function may determine the distance between the neural network output and the actual results produced by running the system.

At operation 1040, the derivative is computed to only some of the inputs. For example, the derivative may only be computed for the permanent/property inputs of the neurons, marked with a “P” in FIG. 11. In some embodiments, the neural network can be run such that the derivative is computed only to the “T” inputs. In an illustrative embodiment, when run to the “P inputs, the permanent/property weights of a modeled system can be optimized. When run to the “T” inputs, the initial “T” inputs can be optimized. Although the illustrative example two types of input, “P,” and “T,” there may be more than two types of input. In such systems, one or more input types may have their derivative computed at a time.

In view of the many possible embodiments to which the principles of the disclosed invention may be applied, it should be recognized that the illustrated embodiments are only examples of the invention and should not be taken as limiting the scope of the invention. Rather, the scope of the invention is defined by the following claims. We therefore claim as our invention all that comes within the scope and spirit of these claims.

We claim:

1. A method to create a neural network that solves a linked network of equations, implemented in a computing system comprising one or more processors and one or more memories coupled to the one or more processors, the one or more memories comprising computer-executable instructions for causing the computing system to perform operations comprising:
creating object neurons for functions in the linked network of functions, the functions having: respective external variables that that are inputs into respective functions, and respective internal properties of the respective functions;
arranging object neurons in order of the linked functions such that a function is associated with a corresponding object neuron; and
assigning the associated equation to an activation function of each respective object neuron.

2. The method of claim 1, wherein the activation functions are differentiable.

3. The method of claim 1, further comprising connecting the object neurons where each respective equation external variable is an edge of the corresponding object neuron and wherein a value of the external variable is a weight for the edge.

4. The method of claim 3 wherein at least two activation functions represent unrelated equations.

5. The method of claim 4, wherein respective functions have respective internal properties.

6. The method of claim 5, further comprising creating for an internal property of a function, an input associated with the corresponding object neuron, the input having an edge that connects to the corresponding object neuron.

7. The method of claim 2, wherein a first object neuron has multiple edges connected to a downstream neuron, and a different number of multiple edges connected to an upstream neuron.

8. The method of claim 1, wherein an activation function is comprised of multiple equations

9. The method of claim 1, wherein at least two functions in the linked network of functions are unrelated.

10. The method of claim 9, further comprising computing the derivative of the neural network to minimize a cost function.

11. The method of claim 10, wherein the neural net has inputs into the neural net and wherein computing the derivative of the neural network applies to a subset of inputs into the neural net.

12. The method of claim 11, wherein computing the derivative of the neural network applies to permanent neuron inputs or to temporary neuron inputs.

13. The method of claim 12 wherein computing the derivative of the neural network comprises using backpropagation or automatic differentiation.

14. The method of claim 13, wherein the cost function determines the distance between neural network output and real-word data associated with a system associated with the linked network of equations.

15. A system comprising: at least one processor; a memory in operable communication with the processor, computing code associated with the processor configured to create a neural network corresponding to a series of functions, the functions being linked, the functions having input variables and output variables, at least one function having an upstream function which passes at least one variable to the function and a downstream function, to which is passed at least one variable by the function, comprising: performing a process that includes (a) associating a neuron with each function, creating associated neurons for each function,
(b) arranging the associated neurons in order of the linked functions,
(c) creating, for each function input variable, an edge for the neuron corresponding to the function, the edge having an upstream end and a downstream end,
(d) connecting the downstream end to the neuron,
(e) connecting the upstream end to the a neuron associated with the upstream function,
(f) creating, for each function output variable, an edge for the neuron corresponding to the function, the edge having an upstream end and a downstream end,
(g) connecting the upstream end to the neuron,
(h) connecting the downstream end to the neuron associated with the downstream function, and
(g) associating each function with an activation function in its associated neuron.

16. The system of claim 15, further comprising a permanent value associated with at least one function; and creating a neural net input for the permanent value.

17. The system of claim 16, wherein there are two permanent values associated with at least one function, creating a neural net input for each of the permanent values, and attaching a downstream edge of the neural net input for to the neuron associated with the at least one function.

18. The system of claim 17, wherein input variables for a most-upstream function correspond to neural network input variables.

19. A computer-readable storage medium configured with instructions which open execution by one or more processors to perform a method for creating a neural network that solves a linked network of functions, the method comprising:
creating object neurons for equations in the linked network of functions, the functions having: respective external variables that that are inputs into the respective functions, and respective internal properties of the respective functions;
arranging object neurons in order of the linked functions such that a function is associated with a corresponding object neuron; and
assigning the associated function to an activation function of each respective object neuron.

20. The computer-readable storage medium of claim 19, wherein at least two activation functions represent unrelated functions.
